(19) United States
(12) Patent Application Publication
(10) Pub. No.: US 2007/0257574 A1
(43) Pub. Date: Nov. 8, 2007

(54) Spindle motor

(75) Inventors: Pyo Kim, Gyunggi-do (KR); Nam Seok Kim, Gyunggi-do (KR); Sang Kyu Lee, Gyunggi-do (KR); Viatcheslav Smirnov, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/797,346

(22) Filed: May 2, 2007

(30) Foreign Application Priority Data
May 2, 2006 (KR) 10-2006-0039551

(51) Int. Cl. H02K 7/00; H02K 5/16

(52) U.S. Cl. 310/90; 310/67 R

(57) ABSTRACT

The present invention provides a spindle motor. The spindle motor includes a frame provided with a tubular holder mounted to the center of the frame such that the holder is projected upwards, with a core mounted on the outer circumferential surface of the holder; a bearing fitted into the tubular holder, the bearing being divided into upper and lower parts, with an outside groove formed on the inner surface of the bearing along an interface between the upper and lower parts of the bearing; a shaft rotatably inserted into the bearing, with an inside groove formed on the outer surface of the shaft at a location corresponding to the outside groove of the bearing; a rotor mounted to the upper end of the shaft and having a shape of an inverted open cap, with a magnet provided on the inner surface of a skirt of the rotor such that the magnet faces the core with a gap defined between them; a thrust plate closing the lower end of the frame, with the bearing fitted into the lower end of the frame; and an annular stopper placed in a space defined both by the inside groove and by the outside groove and preventing axial movement of the shaft.

### CROSS REFERENCE TO RELATED APPLICATION

This application claims the benefit of Korean Patent Application No. 10-2006-0039551, filed on May 2, 2006, entitled Spindle Motor, which is hereby incorporated by reference in its entirety into this application.

### BACKGROUND OF THE INVENTION

1. Field of the Invention

The present invention relates, in general, to spindle motors used in precision drive devices, such as optical disc drives, and, more particularly, to a spindle motor, which secures a maximum contact surface between a motor shaft and a bearing and stably holds the shaft in the bearing, thus realizing compactness and lightness of spindle motors without reducing the driving performance of the spindle motors.

2. Description of the Related Art

Generally, conventional motors have been classified into rotary shaft-type motors and fixed shaft-type motors according to the method of supporting the motor shafts, and classified into rolling bearing-type motors and sliding bearing-type motors according to the method of supporting the drive parts of the motors.

A conventional rolling bearing-type motor is configured such that the motor shaft is supported by at least one ball bearing. This rolling bearing-type motor is advantageous in that it uses an inexpensive ball bearing to rotatably support the motor shaft, thus reducing the production cost of motors, and the balls, placed between the inner and outer races of the ball bearing, have high strength, thus being effectively used for a lengthy period of time.

However, the rolling bearing-type motor is problematic in that it cannot provide high rotational precision, so that it is not effectively used in a product requiring high speed and constant speed rotation although it can be preferably used in products requiring low speed rotation.

Described in detail, when the rolling bearing-type motor is used as a motor of a drive device for rotating a recording medium, requiring high speed rotation, severe vibration may be generated due to the gap defined between the balls and the inner and outer races, thus generating operating noise.

The sliding bearing-type motor is configured such that the shaft is supported by a metal bearing laden with lubrication oil or by an oil film formed from oil. In comparison with the rolling bearing-type motor using a ball bearing, the sliding bearing-type motor increases the production cost of the motor. However, the sliding bearing-type motor is advantageous in that it maintains high precision rotating performance, so that the sliding bearing-type motor has been preferably used as a motor of drive devices for rotating recording media, requiring high speed rotation, such as hard disk drives (HDD) or optical disc drives (ODD).

In the drive devices for rotating recording media at high speeds, the most important factor is to rotate a disc at a high speed without vibrating the disc. To rotate a disc at a high speed without vibrating the disc, the spindle motor must have high durability and must maintain stable balance of a turn table on which a disc is seated and is rotated at a high speed.

FIG. 1 is a sectional view illustrating a conventional spindle motor. As shown in FIG. 1, the spindle motor comprises a stationary part, which comprises a frame 110, a bearing 120 and a core 130, and a rotary part, which comprises a shaft 150, a rotor 160 and a magnet 165.

The frame 110 comprises a tubular holder 115, which is fitted in the center of the frame 110 such that the holder 115 is projected upwards. The bearing 120 is axially seated in the tubular holder 115. The core 130, which has a coil, is securely fitted over the holder 115.

When the shaft 150 is rotated at a high speed, a lift force acts on the shaft 150 so that the shaft 150 is lifted up along with the rotor 160. To prevent the shaft 150 from being removed from the bearing 120 due to the lift force, an annular groove 151 is formed around the lower part of the shaft 150 and a stopper 155, having an O-ring shape, is fitted over the annular groove 151.

A flat thrust plate 116 is mounted to the open lower end of the holder 115 through caulking or bonding, so that the open lower end of the holder 115 is closed from the outside.

Further, the rotor 160 is securely fitted over the upper end of the shaft 150, which is rotatably inserted into the bearing 120. The rotor 160 has a shape of an inverted open cap with the magnet 165 mounted to the inner surface of the skirt of the rotor 160 such that the magnet 165 faces the outer surface of the core 130.

When electric power is supplied from an external power source to the core 130 of the spindle motor, having the above-mentioned construction, an electromagnetic force is generated between the core 130 and the magnet 165, thus electromagnetically rotating the magnet 165, which constitutes the rotary part of the motor. Therefore, the rotor 160 is rotated in conjunction with the magnet 165 and then rotates the shaft 150, which is integrated with the rotor 160.

In response to the recent trend of compactness and lightness of precision machines, it is required to realize compactness and lightness of the spindle motors used in the precision machines. However, the degree of freedom while designing spindle motors to realize compactness and lightness of the motors according to the related art is very low, so that it is very difficult to realize compactness and lightness of the conventional spindle motors.

Described in detail, in the conventional spindle motor, the stopper 155, which has a shape of an O-ring, is fitted over the lower part of the shaft 150, thus preventing the shaft 150 from being removed from the bearing 120. However, due to the thickness of the stopper 155 and a space required to install the stopper 155 in the motor, an effective contact surface between the bearing 120 and the shaft 150 is undesirably reduced.

Thus, to secure a stable driving performance of the spindle motor, it is necessary to secure a large effective contact surface between the bearing 120 and the shaft 150. To realize the increase in the effective contact surface between the bearing 120 and the shaft 150 in the conventional spindle motor, the length of the shaft 150 must be increased, resulting in an increase in the size of the spindle motor. Therefore, in the related art, it is very difficult to produce a compact spindle motor due to a structural fault thereof. If a compact spindle motor is produced in the related art, the motor may undesirably have inferior driving performance.

### SUMMARY OF THE INVENTION

Accordingly, the present invention has been made keeping in mind the above problems occurring in the related art, and an object of the present invention is to provide a spindle motor, which stably holds a shaft in a bearing without reducing the effective contact surface between the bearing and the shaft, and increases the degree of freedom while designing the motor to realize compactness of the motor.

In order to achieve the above object, according to one aspect of the present invention, there is provided a spindle motor comprising: a frame provided with a tubular holder mounted to the center of the frame such that the holder is projected upwards, with a core mounted on the outer circumferential surface of the holder; a bearing fitted into the tubular holder of the frame, the bearing being divided into upper and lower parts, with an outside groove formed on the inner surface of the bearing along an interface between the upper and lower parts of the bearing; a shaft rotatably inserted into the bearing, with an inside groove formed on the outer surface of the shaft at a location corresponding to the outside groove of the bearing; a rotor mounted to the upper end of the shaft and having a shape of an inverted open cap, with a magnet provided on the inner surface of a skirt of the rotor such that the magnet faces the core with a gap defined between the core and the magnet; a thrust plate closing the lower end of the frame, with the bearing fitted into the lower end of the frame; and an annular stopper placed in a space defined both by the inside groove and by the outside groove and preventing axial movement of the shaft.

In the spindle motor, the outside groove of the bearing may be provided with an inclined surface such that a leading angle in the inlet of the outside groove is reduced.

In the spindle motor, the outside groove of the bearing may be configured such that the outer circumferential part of the annular stopper is fitted into the outside groove, and the inside groove of the shaft may have a size larger than the size of the outside groove such that the stopper is in noncontact with the inside groove of the shaft.

In the spindle motor, an edge of the annular stopper, at which the inner surface and the upper surface of the stopper meet each other, may be chamfered, thus forming an inclined surface.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a sectional view illustrating a conventional spindle motor;

FIG. 2 is a sectional view illustrating a half of a spindle motor according to a first embodiment of the present invention;

FIG. 3 is a partially sectioned perspective view of an important part of the spindle motor of FIG. 2;

FIG. 4 is a sectional view illustrating an important part of a spindle motor according to a second embodiment of the present invention; and

FIG. 5 is a perspective view illustrating a stopper of the spindle motor of FIG. 4.

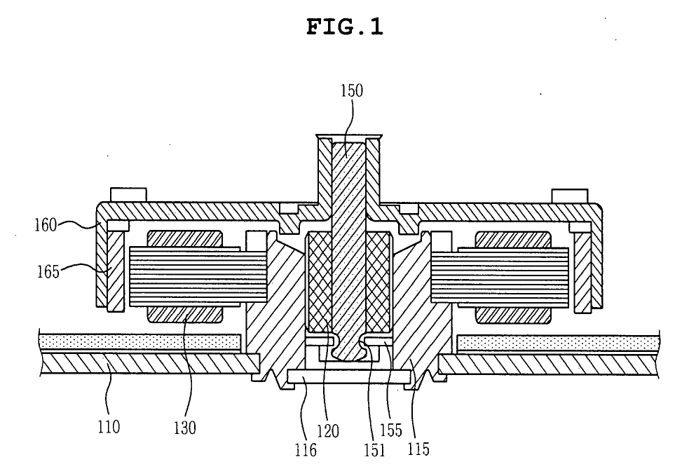

### DETAILED DESCRIPTION OF THE INVENTION

Reference will now be made in greater detail to preferred embodiments of the invention, examples of which are illustrated in the accompanying drawings. Wherever possible, the same reference numerals will be used throughout the drawings and the description to refer to the same or like parts.

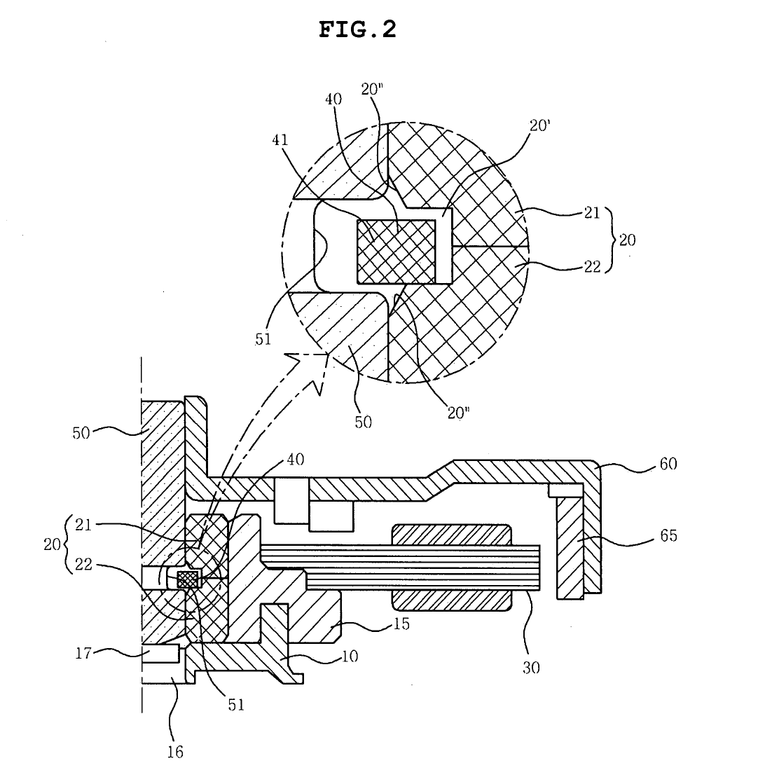

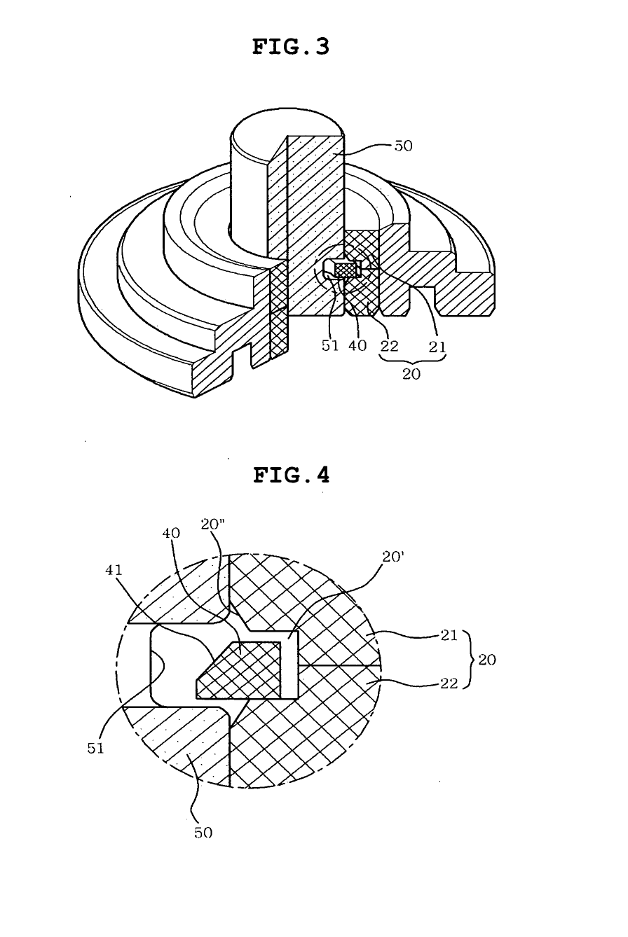

FIG. 2 and FIG. 3 illustrate a spindle motor according to a first embodiment of the present invention. First, the spindle motor according to the first embodiment of the present invention will be described hereinbelow, with reference to FIG. 2.

As shown in FIG. 2, the spindle motor 1 according to the first embodiment of the present invention comprises a stationary part, which comprises a frame 10, a metal bearing 20 and a core 30, and a rotary part, which comprises a shaft 50, a rotor 60 and a magnet 65.

First, the elements of the stationary part will be described in detail hereinbelow. The frame 10 comprises a tubular holder 15, which is fitted in the center of the frame 10 such that the holder 15 is projected upwards. The bearing 20 is axially and forcibly fitted in the tubular holder 15. Further, the core 30, which has a coil to which electric power is selectively applied, is fitted over the holder 15. In the above state, the core 30 is placed such that it faces the magnet 65, which is mounted to the inner surface of the rotor 60, as will be described later herein, with a gap defined between the core 30 and the magnet 65. Thus, when electric power is applied to the core 30, an electromagnetic force is generated between the core 30 and the magnet 65.

The elements of the rotary part will be described in detail hereinbelow. The shaft 50 is rotatably inserted into a shaft hole, which is axially formed through the center of the bearing 20. Further, the rotor 60 is fitted over the upper end of the shaft 50, which is rotatably inserted into the bearing 20. The rotor 60 has a shape of an inverted open cap, with the magnet 65 mounted to the inner surface of the skirt of the rotor 60 such that the magnet 65 faces the outer surface of the core 30 with a gap defined between the core 30 and the magnet 65. Thus, when electric power is applied to the core 30, an electromagnetic force is generated between the core 30 and the magnet 65.

A thrust plate 16 is mounted to the open lower end of the shaft hole, which extends through the centers of both the frame 10 and the bearing 20, so that the open lower end of the shaft hole is closed from the outside. Further, a flat thrust washer 17 is preferably provided between the lower end of the shaft 50 and the upper surface of the thrust plate 16, thus supporting the shaft 50 when the shaft 50 is rotated.

When electric power is supplied from an external power source to the spindle motor 1, having the above-mentioned construction, an electromagnetic force is generated between the core 30 and the magnet 65, thus electromagnetically rotating the magnet 65, which constitutes the rotary part of the motor 1. Therefore, the rotor 60 is rotated in conjunction with the magnet 65 and then rotates the shaft 50, which is integrated with the rotor 60.

The above-mentioned construction and operation of the spindle motor 1 of the present invention are similar to those of the conventional spindle motor. However, unlike the conventional spindle motor, the spindle motor 1 of the present invention is characterized in that a stopper 40 is provided on the effective contact surface between the bearing 20 and the shaft 50 and prevents undesired removal of the shaft 50 from the bearing 20.

To place the stopper 40 in the spindle motor 1 of the present invention, an outside annular groove 20′ and an inside annular groove 51 are formed on the bearing 20 and the shaft 50, respectively, in the middle portion of the effective contact surface between the bearing 20 and the shaft 50, thus receiving an annular stopper 40 therein. The stopper 40 and the grooves 20′ and 51 will be described in detail hereinbelow with reference to FIG. 3.

The bearing 20 is divided into two tubular parts, that are an upper tubular bearing part 21 and a lower tubular bearing part 22. The outside annular groove 20′ is formed around the inner surface of the bearing 20 along the interface between the upper bearing part 21 and the lower bearing part 22.

In other words, a first groove, having an L-shaped section, is formed around the lower edge of the inner surface of the upper bearing part 21, and a second groove, having an L-shaped section, is formed around the upper edge of the inner surface of the lower bearing part 22. Thus, when the upper and lower bearing parts 21 and 22 are assembled with each other to form the bearing 20, the first and second grooves form the outside annular groove 20′ having a U-shaped section.

Further, the opposite edges of the outside annular groove 20′ of the bearing 20 are chamfered to form inclined surfaces 20″, thus reducing the leading angles in the inlet of the outside annular groove 20′. The inclined surfaces 20″ of the outside annular groove 20′ allow the stopper 40 to be smoothly inserted into the outside annular groove 20′.

The outside annular groove 20′ of the bearing 20 is preferably sized such that the outer circumferential part of the annular stopper 40 can be forcibly fitted into the outside annular groove 20′.

The outside annular groove 20′ of the bearing 20, having the above-mentioned construction, forms an annular space in cooperation with the inside annular groove 51 of the shaft 50, which will be described later herein.

The inside annular groove 51, having a shape correspond to the shape of the outside annular groove 20′ of the bearing 20, is formed around the outer surface of the shaft 50 at a location facing the outside annular groove 20′ of the bearing 20. The inside annular groove 51 has a U-shaped section corresponding to the section of the outside annular groove 20′, so that, when the bearing 20 and the shaft 50 are assembled with each other, the inside annular groove 51 and the outside annular groove 20′ form a groove having a rectangular section.

When the shaft 50 is in contact with the stopper 40, the driving performance of the spindle motor 1 may be reduced due to friction between the shaft 50 and the stopper 40, so that it is preferred to make the size of the inside annular groove 51 be larger than that of the outside annular groove 20′. Thus, in a normal operation of the spindle motor 1, the inside part of the stopper 40 is not in contact with the inside annular groove 51 of the shaft 50, thereby realizing the stable driving performance of the spindle motor 1. Further, when an axial lift force acts both on the rotor 60 and on the shaft 50, the inside annular groove 51 of the shaft 50 comes into contact with the stopper 40, so that the rotor 60 and the shaft 50 can stop their axial movement.

When the shaft 50, having the above-mentioned construction, is rotatably inserted into the bearing 20, the inside annular groove 51 of the shaft 50 faces the outside annular groove 20′ of the bearing 20, so that an annular groove is defined the effect contact surface between the bearing 20 and the shaft 50, with the annular stopper 40 seated in the annular groove.

The stopper 40 is an annular product having a predetermined thickness, which is produced through pressing. The inner diameter of the stopper 40 is determined such that the stopper 40 is not in contact with the inner surface of the inside annular groove 51 of the shaft 50 and the outer diameter of the stopper 40 is determined such that the stopper 40 is frictionally fitted into the outside annular groove 20′ of the bearing 20.

The stopper 40, having the above-mentioned construction, is placed in the annular groove, which is formed both by the inside annular groove 51 of the shaft 50 and by the outside annular groove 20′ of the bearing 20, so that the stopper 40 restricts axial movement of the shaft 50 in the bearing 20 due to a lift force.

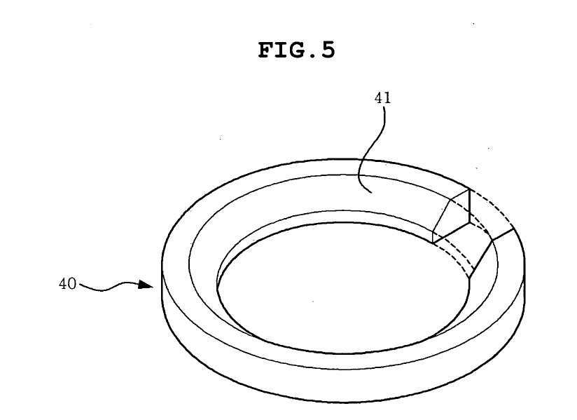

FIG. 4 is a sectional view illustrating an important part of a spindle motor according to a second embodiment of the present invention. FIG. 5 is a perspective view illustrating a stopper of the spindle motor of FIG. 4.

In the second embodiment of the present invention, an upper edge of the inner surface of the annular stopper 40 is chamfered to reduce the friction between the shaft 50 and the stopper 40 when the shaft 50 is fitted into the bearing 20, thus improving work efficiency while assembling the shaft 50 with the bearing 20.

Described in detail, the upper edge, at which the inner surface and the upper surface of the stopper 40 meet each other, is chamfered, thus forming an inclined surface 41. When the spindle motor 1 is operated and the shaft 50 is thrust downwards, the inclined surface 41 is brought into diagonal contact with the contact end of the shaft 50, thus reducing the thrust force acting on the shaft 50.

The assembling process and operation of the spindle motor of the present invention, having the above-mentioned construction, will be described hereinbelow.

To assemble the elements into a spindle motor 1, the holder 15 with the core 30 fitted over the holder 15 is mounted on the frame 10. The lower bearing part 22 is fitted into the holder 15. Thereafter, the open lower end of the frame 10 and the bearing 20 is closed by the thrust plate 16.

Thereafter, the stopper 40 is preliminarily fitted over the inside annular groove 51 of the shaft 50. Thereafter, the shaft 50, having the stopper 40, is fitted into the lower bearing part 22. Thereafter, the upper bearing part 21 is fitted into the holder 15, which has the stopper 40, such that the lower surface of the upper bearing part 21 comes into close contact with the upper surface of the lower bearing part 22.

When the rotor 60 is fitted over the upper end of the shaft 50 in the above state, the elements of the spindle motor are completely assembled with each other.

When an external force, such as a lift force, acts on the rotor 60 during the operation of the spindle motor 1, the stopper 40 prevents the rotor 60 from being moved in an axial direction.

In other words, when electric power is applied from an external power source to the core 30, an electromagnetic force is generated between the core 30 and the magnet 65, thus rotating the rotor 60 having the magnet 65. When the rotor 60 is rotated as described above, the shaft 50, which is assembled with the rotor 60, is rotated in the same direction. In the above state, both the rotor 60 and the shaft 50, which constitute the rotary part, are rotated at a high speed, so that a lift force acts on both the rotor 60 and the shaft 50 and biases them upwards in an axial direction. However, in the spindle motor 1 of the present invention, the stopper 40, which is fitted into the outside annular groove 20′ of the bearing 20, catches the inside annular groove 51 of the shaft 50, thus preventing axial movement of both the rotor 60 and the shaft 50 of the rotary part.

Particularly, the stopper 40, which prevents axial movement of both the rotor 60 and the shaft 50, is placed around the interface between the upper bearing part 21 and the lower bearing part 22 of the bearing 20, so that the present invention can remove a conventional structure, which is provided on the lower end of the shaft 50 to prevent axial movement both the rotor 60 and the shaft 50.

Therefore, in the spindle motor 1 of the present invention, the shaft 50 has a reduced length without reducing the effective contact surface between the bearing 20 and the shaft 50, so that the present invention efficiently reduces a thickness of the motor and realizes compactness and lightness of the motor while securing desired driving performance of the motor.

As apparent from the above description, the spindle motor according to the present invention provides advantages in that a stopper is placed between the shaft and the bearing, thus preventing axial movement of the shaft without reducing the effective contact surface between the shaft and the bearing. Therefore, the present invention remarkably increases the degree of freedom while designing spindle motors to realize compactness and lightness of the motors.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A spindle motor comprising:
a frame provided with a tubular holder mounted to a center of the frame such that the holder is projected upwards, with a core mounted on an outer circumferential surface of the holder;
a bearing fitted into the tubular holder of the frame, the bearing being divided into upper and lower parts, with an outside groove formed on an inner surface of the bearing along an interface between the upper and lower parts of the bearing;
a shaft rotatably inserted into the bearing, with an inside groove formed on an outer surface of the shaft at a location corresponding to the outside groove of the bearing;
a rotor mounted to an upper end of the shaft and having a shape of an inverted open cap, with a magnet provided on an inner surface of a skirt of the rotor such that the magnet faces the core with a gap defined between the core and the magnet;
a thrust plate closing a lower end of the frame, with the bearing fitted into the lower end of the frame; and
an annular stopper placed in a space defined both by the inside groove and by the outside groove and preventing axial movement of the shaft.

2. The spindle motor according to claim 1, wherein the outside groove of the bearing is provided with an inclined surface such that a leading angle in an inlet of the outside groove is reduced.

3. The spindle motor according to claim 1, wherein the outside groove of the bearing is configured such that an outer part of the annular stopper is fitted into the outside groove, and the inside groove of the shaft has a size larger than a size of the outside groove such that the stopper is in noncontact with the inside groove of the shaft.

4. The spindle motor according to claim 2, wherein the outside groove of the bearing is configured such that an outer part of the annular stopper is fitted into the outside groove, and the inside groove of the shaft has a size larger than a size of the outside groove such that the stopper is in noncontact with the inside groove of the shaft.

5. The spindle motor according to claim 1, wherein an edge of the annular stopper, at which an inner surface and an upper surface of the stopper meet each other, is chamfered, thus forming an inclined surface.
